(19) United States
(12) Patent Application Publication
(10) Pub. No.: US 2003/0094196 A1
(43) Pub. Date: May 22, 2003

(54) Advanced process control for immersion processing

(76) Inventors: Kevin L. Siefering, Excelsior, MN (US); Phillip Andrew Grothe, Eden Prairie, MN (US); David Scott Becker, Excelsior, MN (US)

Correspondence Address: KAGAN BINDER, PLLC, SUITE 200, MAPLE ISLAND BUILDING, 221 MAIN STREET NORTH, STILLWATER, MN, 55082, US

(21) Appl. No.: 10/290,768

(22) Filed: Nov. 8, 2002

Related U.S. Application Data
(60) Provisional application No. 60/338,058, filed on Nov. 13, 2001.

(51) Int. Cl. G05D 11/00

(52) U.S. Cl. 137/93

(57) ABSTRACT

The present invention provides immersion chemical processing systems capable of providing a desired blend of at least two chemicals to an immersion bath as well as methods of treating substrates immersively. The system is capable of producing a blend with one or more desired properties extremely accurately due at least in part to the capability of the system to monitor at least one property of the blend or at least one parameter of the immersion process and to utilize the information gathered to provide dynamic closed-loop feedback control of one or more process parameters known to relate to the same.

### FIELD OF THE INVENTION

The present invention pertains generally to immersion chemical processing systems having the ability to provide a desired blend of two or more components to an immersion bath with a high degree of accuracy and control, to optionally maintain the properties of the blend during processing and/or to adjust the processing parameters to ensure consistent processing of different batches of wafers.

### BACKGROUND OF THE INVENTION

The manufacture of microelectronic devices is often very complex, requiring a plurality of processing steps to be performed utilizing a variety of fluids, liquids and/or solutions. Further, due to the nature of microelectronic devices, the tolerance range for any degree of error or nonconformance to manufacturing standards is extremely low. Inasmuch as the quality of the output of any processing step can often be directly related to the fluid, liquid or solution utilized in conjunction with the same, the integrity of such processing fluids can be critical. Providing this integrity can be a difficult task, in particular when the processing fluids are introduced into an environment that may effect the operative properties (e.g., concentration, temperature, and the like), inasmuch as such environments are present in many processing systems. Further, and although real-time blended solutions or fluids would prove advantageous in many circumstances, providing such solutions in a manner that does not introduce the potential for departure from manufacturing standards is challenging.

Many attempts have been made to provide real-time blended processing fluids that conform to manufacturing processing standards directly into an immersive manufacturing process. Such attempts have focused on, for example, monitoring a property of the blended solution, such as pH, conductivity and the like, and then adjusting the blended solution to conform to the desired standard. Additionally, many have attempted to provide reliable real-time blended solutions by providing particular process parameters that, when used, result in substantially conforming processing fluids. For example, such attempts have utilized components, such as fixed orifices or needle valves, to provide specific flow rates, or fixed volumes or metering pumps to provide predetermined and fixed volumes, of the fluids to be blended.

Such methods have proven effective in many applications, but can be less than optimal in others. Particularly in immersion applications, adjusting a blended solution at the point of use based upon the measurement of a property of the blended solution could prove suboptimal. That is, implementing such a testing and adjusting procedure would require additional processing time to so test and adjust the blended solution prior to initiating treatment each and every time a substrate or set of substrates is desirably processed. Similarly, the use of simple orifices or needle valves to provide specific flow rates of fluids into an immersion bath is not a sufficiently robust solution, inasmuch as it would require reproducible pressure conditions both upstream and downstream in the system to provide a consistent blending ratio. If the pressure conditions were to fluctuate, the desired blend may not be achieved. The use of metering pumps to deliver predetermined fixed volumes may also prove to be problematic in that such pumps are typically incapable of pumping fluid from a pressurized source (a form in which many solutions or fluids are supplied) and tend to operate slowly, thus introducing additional time into the manufacturing process. Finally, the use of flow rate restrictors, such as needle valves or fixed orifices, or static volumetric measuring devices to provide a specific volume of fluid to an immersion vessel, does not allow for flexibility in manufacturing, in that the entire manufacturing system would need to be reconfigured in order to provide for the delivery of other volumes, and thus, other blend ratios.

It would thus be desirable to provide an immersion chemical processing system that is capable of efficiently, rapidly and accurately blending processing fluids in real time for use in the same. Such systems would prove especially advantageous if capable of not only providing such blends in real time, but also maintaining the properties of the blend during processing. It would further be desirable for such systems to be capable of doing so without substantially interrupting the manufacturing process, i.e., as by requiring time to determine the integrity of the blended solution or by requiring additional human intervention in the operation and maintenance of the system. Optimally, such systems would further be flexible so as to be capable for use in blending many different processing fluids for many different applications.

### SUMMARY OF THE INVENTION

The present invention provides immersion chemical processing systems having the ability to provide a desired blend of two or more components to an immersion vessel with a high degree of accuracy and control. More specifically, via the monitoring of at least one property of the blend or at least one parameter of the immersion process, and the utilization of the information gathered to provide preventative feedback control, or closed-loop feedback or feedforward control of one or more process parameters known to relate to the same, the enhanced immersion processing systems are capable of providing, as well as maintaining the operative properties of, real-time blends of two or more components for use in immersion processing, wherein the provided blend has desired properties and/or the processing has desired parameters.

In a first aspect, then, the invention provides a chemical processing system having an immersion vessel. The system comprises at least a first and a second flow control device fluidly coupled to first and second component supplies, respectively. The system further includes a mixing manifold fluidly coupled to the first and second component supplies and for supplying a solution comprising the first and second components to the immersion vessel. A first measuring device is also provided and is operatively disposed relative to the mixing manifold or the immersion vessel. A control system is in communication with the first measuring device, first flow control device, and second flow control device so that measurements from the measuring device can be utilized to dynamically adjust the first and second flow control device, respectively, in response thereto.

In another aspect, the invention provides an immersion chemical processing system. The system comprises first and second processing parameter measuring devices and first and second processing parameter control devices fluidly coupled to first and second component supplies, respectively. A mixing manifold is fluidly coupled to the first and second component supplies and supplies a solution comprising the first and second components to an immersion vessel. A control system is provided that is in communication with the first processing parameter measuring device, first processing parameter control device, second processing parameter measuring device and second processing parameter control device. The control system is capable of utilizing measurements from the first and second processing parameter measuring device to dynamically adjust the first and second processing parameter control device, respectively, in response thereto.

In a further aspect, the invention provides an immersion chemical processing system. The system comprises first and second flow measuring devices and first and second flow control devices fluidly coupled to first and second component supplies, respectively. Desirably, the first and second flow control devices are located downstream from the first and second flow measuring device, respectively. A mixing manifold is fluidly coupled to the first and second component supplies and supplies a solution comprising the first and second components to the immersion vessel. The system further provides a control system in communication with the first flow measuring device, first flow control device, second flow measuring device and second flow control device. In this manner, the system allows measurements from the first and second flow measuring device can be utilized to dynamically adjust the first and second flow control device, respectively, in response thereto.

Systems embodying features of the present invention are capable of providing a blend of at least two components, wherein the blend has a desired property efficiently and accurately. As a result, the invention further provides a method of preparing a blend of at least two components, wherein the resulting blend has a desired property. Specifically, the method comprises determining a flow rate of each of the at least two components that, when the at least two components are caused to be combined at the determined flow rate, would result in the blend having at least an approximation of the desired property. The at least two components are then combined while either or both of the flow rate of the at least two components and the property of the blend is measured on a real time basis. Utilizing the measurement, and also on a real time basis, the flow rate of the two components can be adjusted until the desired property is substantially obtained in the produced blend.

In an additional aspect, the present invention provides a method of immersively treating one or more substrates with a blend of at least two components, wherein the blend is produced in real time and has a desired property. The method involves providing a source of each of the at least two components and causing the at least two components to be combined. While so combining the at least two components, at least one property of the blend or at least one parameter of the combination process is monitored. The information obtained from monitoring, can then be utilized to provide closed loop feedback control of the one or more combination parameters to obtain a blend having the desired property, which is then caused to immersively contact the substrates. Optionally, the information obtained from monitoring may advantageously be used in a closed loop feedforward fashion, i.e., to cause future predetermined processing steps to be adjusted in light thereof.

In another aspect of the present invention, the present invention provides a method of immersively treating one or more substrates with a blend having a desired property and prepared from at least two components. In particular, the method involves the steps of providing a source of each of the at least two components. The at least two components are combined while monitoring at least one property of the blend or at least one parameter of the combination process. The substrates are then desirably treated while information obtained from the monitoring is utilized to provide preventative feedback or closed loop feedforward control of one or more combination parameters.

It has further been discovered that information obtained from monitoring a current process of treating one or more substrates may be effectively utilized in the optimization of a future process for treating the one or more substrates. As a result, in yet a further aspect, the present invention also provides a method of processing one or more substrates. The method involves immersively treating the substrates with a blend of at least two components while monitoring either or both of at least one processing parameter and at least one property of the treatment blend. The substrates are then removed from immersive contact and subjected to at least a second processing step. The information obtained from monitoring either or both of at least one processing parameter and at least one property of the first processing step is then utilized to provide closed loop feedforward control of the second processing step.

These and other advantages of the invention will become more apparent from the following detailed description of the invention and the accompanying exemplary drawings.

### BRIEF DESCRIPTION OF THE DRAWINGS

The accompanying drawings, which are incorporated in and constitute a part of this application, illustrate several aspects of the invention. Together with the description of the embodiments serve to explain the principles of the invention. A brief description of the drawings is as follows:

FIG. 1 is a schematic diagram of a system capable of providing preventative feedback, or closed-loop feedback or feedforward control of one or more properties of a real-time prepared blend, one or more process parameters, and/or calibration of a processing component in accordance with the present invention;

FIG. 2 is a schematic diagram of an exemplary cleaning, rinsing and etching system capable of providing preventative feedback, or closed loop feedback or feedforward control of one or more properties of a real-time prepared blend, one or more process parameters, and/or calibration of a processing component in accordance with the present invention;

FIG. 3 is a schematic diagram of an exemplary etching system with a controllable recirculation feature that is capable of providing preventative feedback, or closed loop feedback or feedforward control of one or more properties of a real-time blended etchant, one or more process parameters, and/or calibration of a processing component in accordance with the present invention;

FIG. 4 is a schematic diagram of an exemplary cleaning system with a controllable recirculation feature that is capable of providing preventative feedback, or closed loop feedback or feedforward control of one or more properties of a real-time blended cleaning solution, one or more process parameters, and/or calibration of a processing component in accordance with the present invention.

### DETAILED DESCRIPTION OF CERTAIN EMBODIMENTS OF THE INVENTION

The embodiments of the present invention described below are not intended to be exhaustive or to limit the invention to the particular embodiments disclosed in the following detailed description. Rather, the embodiments are described so that others skilled in the art can understand the principles and practices of the present invention.

The present invention provides chemical processing systems capable of accurately blending at least two processing components in real time to provide blends having a desired property or capable of achieving a desired parameter. The inventive systems are further optionally and advantageously capable of maintaining the properties of the blend during processing, so that processing with the same is optimized, as well as being capable of providing a real-time indicator of processing integrity. Indeed, through the utilization of preventative feedback, closed loop feedback and/or closed-loop feedforward control, it has now been discovered that accurate real time blending can be achieved in a manner that is sufficiently robust, flexible and efficient so that the use of the same is not only imminently practical, but also desirable, in immersion chemical treatment systems and processes of treating substrates immersively.

More specifically, systems embodying features of the present invention can provide for the real time monitoring or measurement of one or more properties of the processing component(s) as blended and/or as used in processing, one or more parameters of the process, or any combination of these. The information obtained, be it pH, conductivity, temperature, time, flow rate, or any other property or process parameter, is then provided to a control system and can be utilized in a preventative feedback, closed-loop feedback or feedforward fashion to adjust the current or future processes, if such adjustment is necessary or desirable.

This process of monitoring and adjusting is advantageously dynamic rather than static, occurring a sufficient number of times to provide for the accurate real time blending of the desired components into a desired blend, to provide a real-time indicator of process integrity and to optionally maintain the properties of the blend during processing. Due at least in part to the fact that the monitoring and adjustment process can occur as the components are blended, an accurate blend can be, and is, typically achieved more quickly than can be achieved if the blend is prepared and then tested for conformance and quality. Such a time savings is especially important in the efficient utilization of immersion systems and processes. Further, because monitoring and adjustment can also optionally be carried out during processing, the properties of the blend can be maintained so that processing with the blend is optimized. Finally, because the present inventive systems and processes are capable of monitoring a plurality of properties and/or parameters, preventive feedback from the same can be utilized as an indicator of processing integrity.

The use of a control system to monitor and adjust certain properties or parameters may further provide advantages particularly usefully exploited in connection with immersion systems and processes. That is, unlike immersion systems that rely on mechanical means of delivering fixed volumes in order to provide blending, a control system can be programmed based upon any number of conditions or parameters to control the preparation of any desired blend, from any number of components, thereby rendering the inventive immersion systems incredibly flexible. Furthermore, the use of the control system can minimize or eliminate the introduction of human or mechanical error into the inventive system and processes, i.e., as by process drift or tampering. Such flexibility and robustness is often not only desirable, but extremely beneficial, in immersion systems and processes. In the present inventive systems and processes, the control system can be advantageously used to control the process itself, or future processes, based upon information provided by any number of measuring devices.

A control system in accordance with the present invention can comprise any conventional or developed system capable of receiving actionable input signals from sensors and for providing output signals to control features. Preferably, such a control system comprises one or more microprocessors appropriately combined with memory to permit processing and within which to store relevant control information, such as may have been obtained empirically or analytically. A control system in accordance with the present invention may also comprise components or subsystems appropriately interfaced with one another. For example, a specific immersion processing apparatus may include its own microprocessor based control system.

That system may interface with a control system of the fluid supply system in accordance with the present invention so that measuring or sensing devices utilized within the processing chamber or vessel may provide input and may receive output from the control system of the fluid supply system. That is, a sensed condition or measurement of the immersion process may be utilized in changing a process variable, such as flow rate of a supplied fluid component. Otherwise, a flow rate, temperature or concentration component from the fluid supply system may be utilized in controlling an aspect of the process conducted within the associated immersion vessel. For example, a sensed temperature, flow rate or concentration within the fluid supply may be used to change a processing parameter, such as processing time. Moreover, information provided as sensed or measured from either the fluid supply system or the process chamber or vessel can be utilized as information relevant to another immersion processing apparatus that may be, for example, next in line for processing. Thus, the control system in accordance with the present invention is preferably connected with each immersion processing apparatus and system.

In a preferred embodiment the control system may utilizes a control algorithm for providing an output signal for controllably adjusting the fluid flow in response to an input signal from the flow transducer. Preferably, the process control algorithm is a Proportional, Integral, Differential (PID) control. Generally, PID control is a type of feedback control where the output is a control variable (CV). Generally, the control variable (CV) is based on the error between some predetermined set point (SP) and some measured process variable (PV). Each element of the PID controller refers to a particular action taken on the error and may be generally described by the following equation:

$$ControlVariable = P ( ( SP - PV ) + D \frac{ⅆ ( SP - PV )}{ⅆ t} + I \int ( SP - PV ) ⅆ t )$$

Where SP is the setpoint value, PV is the measured process variable, P is the proportional constant, I is the integral constant, and D is the differential constant. It is known that other control algorithms, such as fuzzy logic and neural network control algorithms, may be used such that the functional aspects of the present invention are realized.

In accordance with the present invention the set point (SP) and the process variable (PV) may be flow, mix, concentration or temperature values and the control variable may be component fluid flow described above. For example, in the case where desired blend or temperature is equal to the measured blend concentration or temperature, the corresponding component flow rates would not change. However if the measured blend, concentration or temperature is above or below the set point of the process variable the component flow could be reduced or increased respectively. The control variable response characteristics are determined by the particular PID parameters chosen and may generally be determined empirically.

Again, and very generally speaking, the present invention provides immersion systems and processes that provide for the measurement of at least one property or at least one process parameter and the utilization of the information obtained thereby in the closed-loop feedback or feedforward control of the current, or future, processes. In certain embodiments, combinations of measurements may advantageously be taken and utilized and could include any combination, and any number, of property and/or process parameter measurements.

The particular property and/or process parameter that is/are measured is not critical, rather, any property and/or process parameter generally known to relate to any process parameter or to the overall process outcome can be utilized. Although no property measurement is required, properties that could advantageously be measured for example, include but are not limited to, temperature, conductivity, concentration, density, pH, pressure, combinations of these and the like.

Desirably, at least one process parameter will be measured and utilized in the control of the inventive system or process. Process parameters that could be measured include any of number of substrates to be processed, time, flow rate, delivered volume, combinations of these and the like. In preferred systems and processes, flow rate is the measured process parameter. As mentioned above, combinations of measurements can be used in order to provide additional checks and assurances of the process and integrity of the real-time blend produced thereby. As but one example, the flow rates of the at least two components, the total flow rate of the blend, and the temperature and conductivity of the combined blend or blend components could be measured.

Any measuring device capable of providing a signal or response by which another action can be determined or controlled can be utilized to effect the measurement or sensing of any number of property and/or process parameters in accordance with the present invention. Representative examples of measuring devices for measuring fluid flow include flow rate transducers, rotameters, ultrasonic measuring devices, paddlewheels, vane meters, and the like. Flow rate measuring devices are preferred that provide a signal usable by a control system, discussed above, and that are indicative of changing flow rates. Flow rate transducers, for example, provide an electrical signal to a control system based upon a determined fluid flow rate that is directed through it.

Suitable flow rate transducers include differential pressure transducers and vortex shedding transducers, and the like, which type of transducer is preferably chosen based upon the measurement accuracy of the transducer for the flow rates to be measured and/or monitored. Instead of providing an electrical signal, a flow rate measuring device may instead provide a pressure signal or a mechanical response that can be sensed and used in a control system based upon its physical movements or changes that can be read to control other process aspects. In addition to flow measuring devices, other transducer type, mechanical type and pressure responsive type measuring devices can be utilized to monitor or sense other properties or process parameters, such as temperature, concentration, conductivity, and the like. In accordance with preferred versions of present invention, measuring devices measuring flow rate are preferably utilized.

For controlling flow rate, conventional valve structures can be utilized, provided that any such valve utilized includes the ability to adjustably control partial fluid flow as opposed to simply opening or closing valves. That is, the flow through the particular valve should be adjustable to obtain variable fluid flows. In connection with the use of flow transducers that generate an electrical signal indicative of fluid flow, it is preferable that the controllable valve have the ability to be responsive to an electrical signal, which signal may be sent directly from a flow transducer or by way of a control system that monitors any number of such measurement devices and provides appropriate instructional signals. More preferably, where an electrical signal is provided to a flow control valve, it is preferable that the valve include the ability to convert an electrical signal to motion.

For example, known devices can be utilized to convert an electrical signal to a pressure response. That is, based upon an electrical signal provided to the device, a pressure output can be converted, which output is variable depending on the variable signal. Such a pressure output can be effectively utilized in opening and closing flow control valves, such as by further opening or closing of a physical valve control needle or plunger against or as permitted by a biasing force.

In those preferred embodiments of the systems and processes of the present invention using a flow sensing transducer as the measuring device, the systems and processes can optionally provide for the dynamic calibration of the measuring device, thereby providing further assurances in the integrity of the real time blend produced by the same. As used herein, the term ‘calibration’ is meant to indicate not only a mechanical or electrical adjustment to a device itself, but also a mathematical correction of the output of a control system controlling the device. In order to provide such dynamic calibration, flow that had passed through and been measured by the flow sensing transducer would be diverted to a calibration vessel in communication with the control system. Generally, the calibration vessel can include a plurality, of liquid level sensors and timing devices, or the ability to communicate with a timing device as provided within a control system, that together allow accurate measurement of the time required to dispense certain volumes of fluid. Based upon the information obtained from the calibration vessel, the control system can operate to automatically recalibrate, periodically recalibrate or recalibrate according to manual input the flow sensing transducer, i.e., as by causing the flow sensing transducer to make an appropriate mechanical or electrical adjustment, or by implementing a mathematical correction of the output of the flow sensing transducer according to the data obtained from the calibration vessel.

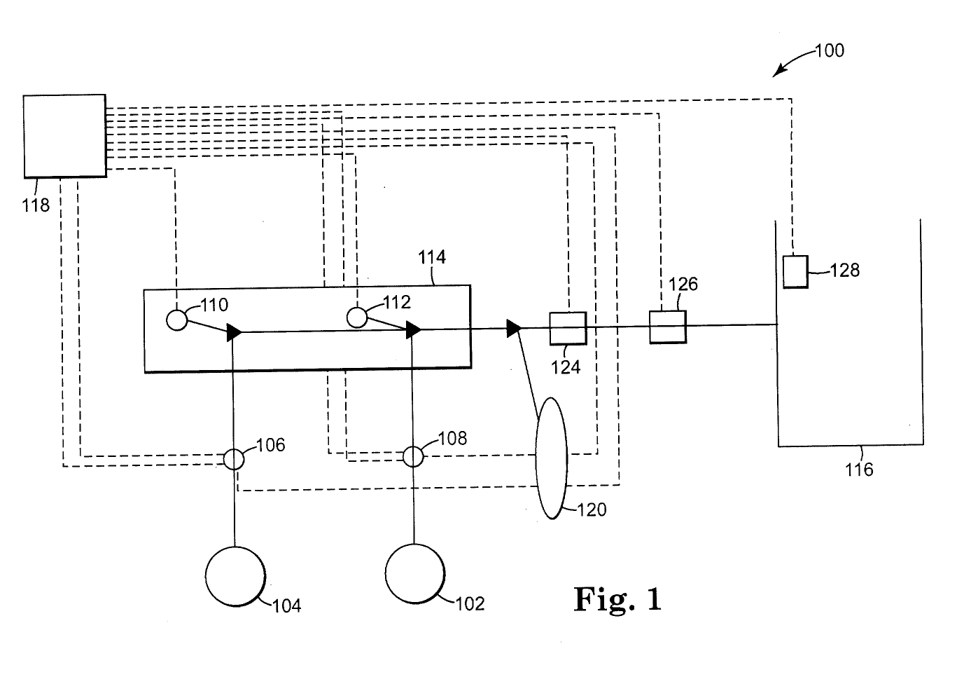

Specifically, a calibration vessel preferred to be usable in accordance with the present invention for calibration flow rate transducers comprises a vessel with a first volume section that leads to a second greater volume section, as schematically illustrated in FIGS. 1-4 at 120, 220, 320 and 420. Within the first encountered smaller volume vessel portion, an initial fluid presence sensor determines when fluid first passes a lower limit of the smaller vessel portion. This initial sensor begins a clock function for starting a timer. A second fluid presence sensor is also partly provided within the smaller vessel portion at a higher level. If the fluid flow is slow enough, this second fluid presence sensor can be utilized to stop the timer so that the clock function can determine the elapsed time. This time information along with the known volume provides sufficient information to determine flow rate. For larger flow rates, a fluid presence sensor is provided at a location within the larger volume vessel portion, or above it in another smaller volume vessel portion, which fluid presence sensor is utilized to stop the timer of the clock function instead of the first vessel portion second sensor so as to more accurately measure a larger flow rate. Again, with the known volumes of the small and large vessel portions, timing information permits easy calculation of flow rate. With this information, accuracy of any particular flow rate of transducer may be precisely measured and monitored. Thus, in order to accurately test any individual flow transducer, only flow through that transducer should be sent to the calibration vessel during this test stage. Any measured changes may easily be used to calibrate or adjust the flow transducer based upon the precisely measured data.

The measurements provided by the one or more measuring devices can be utilized to provide preventative feedback control, closed-loop feedback control or feedforward control to the current process, and/or to provide for the closed-loop feedforward control of a subsequent process.

Preventative feedback control can be exercised, e.g., as by the repetitive measuring of one or more properties or parameters of the system or process, wherein the information obtained relates to a property or parameter of the system or process and is utilized as an indicator of process integrity. More particularly, and in that instance where a system in accordance with the present invention is being utilized to provide a real time blend with a desired concentration, at least two components that are capable of being combined to provide a blend with the desired concentration could be provided. The time of delivery, flow rate or delivered volume of each of the at least two components required to provide a blend having the desired temperature can be approximated. The combination of the least two components would be initiated according to the approximated process parameter. As the at least two components are combined, the concentration of the blend could be measured. If the measured concentration deviated substantially from the concentration that was expected based upon the approximated parameter, the process could be adjusted or shut down, if so required, prior to the occurrence of significant processing error.

Feedback control can be exercised, e.g., by utilizing the measurement to dynamically adjust one or more process parameters known to be capable of having an impact on the measured property or parameter. This could be accomplished by identifying the desired property or parameter, and identifying at least two components, that when combined would be capable of providing a blend having the desired property or exhibiting the desired parameter. The at least two components would then be combined according to an approximated process while the desired property or parameter was measured. If necessary, one or more parameters of the approximated process could be adjusted in response to the measurement, until a blend having the desired property or parameter was obtained.

For example, if the real time preparation of a blend having a particular temperature is desired, at least two components that are capable of being combined to provide a blend with the desired temperature could be provided. The time of delivery, flow rate or delivered volume of each of the at least two components required to provide a blend having the desired temperature can be approximated. The combination of the least two components would be initiated according to the approximated process parameter. As the at least two components are combined, the temperature of the blend could be measured and the measurement utilized to adjust the approximated process parameter, if necessary, until a blend having the desired temperature is prepared.

Feedforward control of the current process can be exercised by utilizing taken measurements to adjust a downstream parameter of the current process. For example, if it is desired to etch one or more substrates according to a timed process, at least two components that are capable of being combined to provide a blend capable of etching the substrates could be provided. The volume, time of delivery, or delivered volume of each of the at least two components required to provide a blend capable of etching the substrates to the desired level and within the allotted time can be approximated. The combination of the at least two components would be initiated according to the approximated process parameter. As the at least two components are combined, various properties of the blend indicative of etch rate, such as concentration, temperature, pH, and the like, could be measured and this information utilized to adjust, in a feedforward fashion, the time of etching so that the desired level of etching can be achieved.

The measurements provided by the one or more measuring devices can also be utilized to provide closed-loop, feedforward control of a subsequent process. That is, it is often times the case in semiconductor device manufacture that one or more substrates, or sets of substrates, proceed through a processing line including several processing systems, that perform several processes. In such cases, the measurements taken according to the process of the present invention as the substrates are being processed in a first system can be utilized in the feedforward control of a subsequent process, as would be implemented by the next downstream processing system. Such feedforward control can be exercised, e.g., by utilizing the measurement to adjust one or more process parameters of the next process known to be capable of being effected by the measured property or parameter. Such a measurement and adjustment could be a dynamic process in those instances when more than one substrate or set of substrates was proceeding through the processing line, as is often the case.

For example, if the subsequent process was at least partially dependent on the initial temperature of the entering substrates, and the temperature of the substrates is either measured, or estimated, based upon the measurement of the temperature of the vessel contents, to depart from the desired temperature, process parameters of the downstream process could be adjusted accordingly to accommodate the true temperature of the substrates while still providing the desired outcome of the downstream process.

Immersion systems embodying features of the present invention are expected to be useful to prepare any blended solution, and to perform any immersive treatment. As a result, the particular blend prepared by the inventive immersion systems and processes is not restricted, and useful blends can include, for example, etching solutions, cleaning solutions, rinsing solutions, oxidizing solutions, and the like. To illustrate the breadth of the scope of the inventive system, one example of a rinsing solution that could be prepared in real time using the inventive system or process would be a solution of hot water. Such a solution could be prepared from two or more water components at differing temperatures capable of being combined to provide water at the desired temperature.

Furthermore, the blends prepared by the systems and processes can be prepared from any number of components utilizing the principles and practices described herein. Also, the inventive immersion systems and processes can include or incorporate any additional components conventionally utilized in corresponding immersion treatment applications without interfering in the performance of the inventive immersion systems and processes. Such additional components could include, for example, minor amounts of acids, such as hydrochloric acid. The properties or parameters of the delivery of such components the same, need not necessarily be measured and/or controlled by the inventive systems and processes, but optionally could be. Finally, as used herein, the term ‘component’ as used herein is meant to indicate any processable material that can be utilized in the manufacture of semiconductor devices, and can include, for example, gasses, fluids, liquids, solutions, slurries, and the like.

Referring now to FIG. 1, there is illustrated a schematic diagram of an exemplary system 100 embodying features of the present invention. In particular, FIG. 1 illustrates system 100 capable of providing preventative feedback, closed loop feedback control or closed loop feedforward control of one or more properties of a real-time prepared blend, one or more process parameters, and/or calibration of a processing component in accordance with the present invention.

For purposes of providing an overview of its operation, system 100 is shown including component supplies 102 and 104, flow transducers 106 and 108, flow control valves 110 and 112, mixing manifold 114, immersion vessel 116, control system 118, calibration vessel 120, total flow measuring device 124, and property measuring devices 126 and 128. Control system 118 provides means for measurements as may be provided by either or both flow transducers 106 and 108, measuring device 124 or property measuring devices 126 and 128 to control any process parameter such as the flow provided by flow control valves 110 and 112, or the time of processing, as well as properties of the blended solution. Of course, various other components, such as filters, check valves, pressure transducers, pressure regulator and the like may be included in system 100 if desired. Control system 118 further provides for the real time mechanical, electrical or mathematical calibration of either or both flow transducers 106 and 108 via information obtained from calibration vessel 120. Indeed, control system 118 can use any of the information provided by any of the measuring devices to control any process parameter or any property of the real-time blended fluid, as desired. In particular, system 100 includes flow transducer 106 and flow control valve 110 fluidly coupled to component supply 104. Flow control valve 110 is located downstream from flow transducer 106. Flow transducer 108 and flow control valve 112 are fluidly coupled to component supply 102, flow control valve 112 being located downstream from flow transducer 108. Flow transducers 106 and 108 provide real time electronic signals indicative of the flow rate of component from component supplies 104 and 102, respectively, to control system 118. Control system 118 is capable of generating electronic signals in response thereto, or any other measurements provided by system 100, that are receivable and actionable by control valves 110 and 112. Flow control valves 110 and 112 can control the flow rate delivered from component supplies 104 and 102, respectively, in response to electronic signals generated by control system 118. Components from component supplies 102 and 104 are thus supplied to mixing manifold 114, and then to immersion vessel 116, at a dynamically controlled flow rate in response to real time measurements.

Calibration vessel 120 is controllably fluidly coupled to component supply 104 downstream from flow control valve 110 and to component supply 102 downstream from flow control valve 112. Flow may be diverted from flow control valves 110 and 112 and caused to flow into calibration vessel 120. In this manner, calibration vessel 120 is capable of providing real time electronic signals indicative of the flow rate of components supplied from flow control valves 110 and 112. Control system 118 is capable of performing a mathematical recalibration of flow control valves 110 and 112 in response thereto and generating electronic signals indicative of the results of this mathematical recalibration that are receivable and actionable by flow transducers 106 and 108. Flow transducers 106 and 108 can thus be dynamically recalibrated by control system 118. If desired, total flow transducer could be fluidly connected to calibration vessel 120 as well, to allow the similar recalibration thereof.

System 100 further includes total flow transducer 124 fluidly coupled to mixing manifold 114 and located downstream therefrom. Total flow transducer 124 is capable of providing real time electronic signals indicative of the total flow rate of the real-time prepared blend delivered from flow control valves 110 and 112 to control system 118. Control system 118 is capable of generating electronic signals in response thereto, receivable and actonable by control valves 110 and/or 112 or by flow transducers 106 and 108. In this fashion, total flow transducer 124 can act as a further check on the accuracy of flow transducers 106 and/or 108.

System 100 further illustrates optional property measuring device 126 fluidly coupled to mixing manifold 114 and located downstream therefrom, as well as optional property measuring device 128 operatively disposed in relation to immersion vessel 116. Property measuring device 126 and 128, if either or both are provided, can be the same or different and can be any device capable of making a property measurement and producing an actionable signal in response thereto. For example, property measuring devices 126 and 128 could be concentration measuring devices such as conductivity sensors, pH meters, spectrometers; thermometers or a combination of these. Property measuring devices 126 and 128, if either or both are provided, provide real time electronic signals indicative of the measured properties of the blend provided to immersion vessel 116 in the case of property measuring device 128, to control system 118. These measurements could then be utilized by control system 118 to adjust parameters such as time of processing or the flow rates provided from component supplies 104 and 102, if necessary.

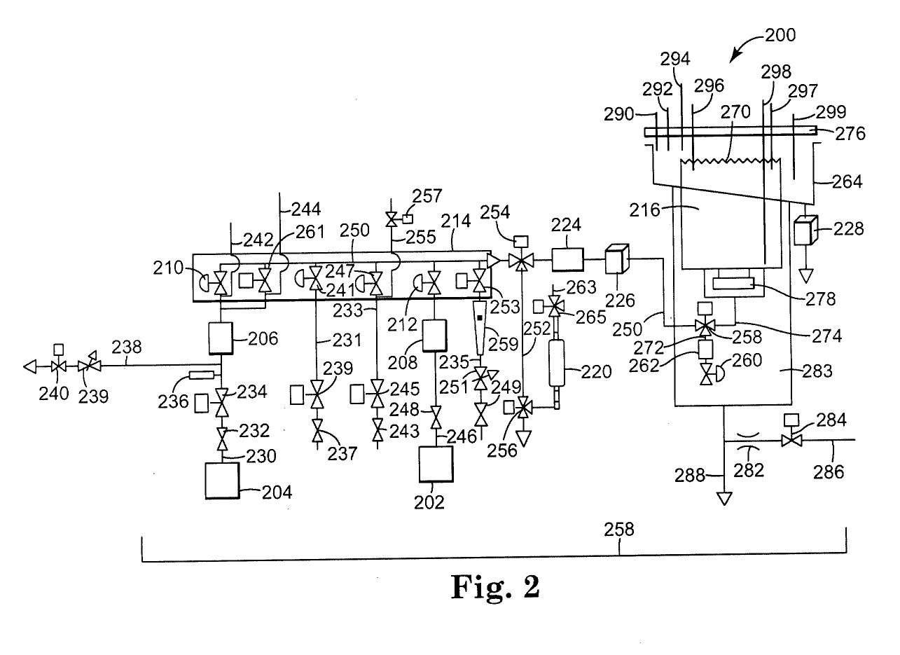

Referring now to FIG. 2, there is shown in more detail a system 200 useful for cleaning, etching and rinsing substrates in accordance with the present invention. Generally, system 200 includes component supplies 202 and 204, flow transducers 206 and 208, flow control valves 210 and 212, mixing manifold 214, calibration vessel 220, total flow transducer 224, property measuring devices 226 and 228 and immersion vessel 216. System 200 further includes a control system (not shown) that receives and responds to information generated by flow transducers 206, 208 and 224 and property measuring devices 226 and 228 to control process parameters such as time of processing or the flow rate provided by flow control valves 210 and 212. Drip pan 258 is provided as a safety measure, in the event of any inadvertent leakage or spillage from system 200 More specifically, component supply 204, which can possibly be a supply of deoxygenated, deionized (DDI) water, is fluidly coupled to mixing manifold 214 via component supply line 230. The flow of component from component supply 204 to mixing manifold 214 is monitored by flow transducer 206 operatively disposed relative to component supply line 230 and in communication with a control system (not shown). Flow rate of component from component supply 204 into mixing manifold 214 can be controlled by controllable valve 210, also in communication with the control system.

Component supply line 230 has operatively disposed relative thereto lockout valve 232, on-off valve 234 and pressure transducer 236 to assist in controlling flow from component supply 204. Also provided with component supply line 230 is end effector rinse spray line 238, fluidly connected to supply line 230 via a valve connector (not shown). End effector rinse spray line 238 has operatively disposed thereon valves 239 and 240 that can be used, if desired, to rinse end effectors utilized to pass substrates, or sets of substrates, into system 200. Bypass lines 242 and 244 are further provided via an on-off valve connection (not shown) in fluid communication with component supply line 230 and may be utilized.

Component supply 202, which can be a supply of hydrofluoric acid (HF), is fluidly coupled to mixing manifold 214 via component supply line 246. The flow of HF from component supply 202 to mixing manifold 214 is monitored by flow transducer 208 operatively disposed relative to component supply line 246 and in communication with the control system (not shown). Flow rate of HF from component supply 202 into mixing manifold 214 can be controlled by controllable valve 212, also in communication with the control system. Component supply line 246 includes valve 248 upstream from component supply 202 and operationally disposed relative to component supply line 246 to assist in controlling flow from component supply 202.

Flow from component supplies 202 and 204 are combined in mixing manifold 214 via the fluid connection of component supply lines 230 and 246 to mixing manifold 214. Mixing manifold 214 is fluidly connected to mixing manifold line 250 that delivers the real time prepared blend to immersion vessel 216. Mixing manifold line 250 has operatively disposed in relation thereto calibration vessel 220, total flow transducer 224 and property measuring device 226. Valve 261 can be closed to divert flow from mixing manifold line 250 and to either or both of bypass lines 242 and 244 when such use is desired.

Calibration vessel 220 is located downstream from mixing manifold 214 and is fluidly connected to mixing manifold line 250 by calibration line 252. Flow from mixing manifold line 250 can be controllably directed through calibration line 252 by three way bypass valve 254. Bypass valve 256 is also provided in fluid connection with calibration line 252, and may be used to direct flow out of calibration line 252, or to allow flow into or out of calibration vessel 220. Calibration vessel 220 is further fluidly coupled to a nitrogen source (not shown) via nitrogen supply line 263 having disposed operationally thereon three way valve 265. Three way valve 265 can be actuated so as to allow venting from calibration vessel 220 when in use, or, once calibration has been filled and calibration effected, can be actuated to allow nitrogen to flow into calibration vessel 222 in order to force the blend therein out and through the drain (not shown) of calibration line 252.

More specifically, if calibration of flow transducers 206 and 208 was desired, flow from either of component supplies 204 and 202 would be initiated and three way bypass valve 254 actuated so as to cause the flow therefrom to flow into calibration line 252. Three way valve 256 would be actuated so as to allow flow in calibration vessel 220. Calibration vessel could then provide information to the control system (not shown) in response to which the control system could initiate a recalibration sequence of transducers 206 and 208, as desired. Calibration vessel 220 thus provides for the controlled recalibration of transducers 206 and/or 208, as desired.

Total flow transducer 224 is also located downstream from mixing manifold 214 and is also in communication with the control system. More specifically, total flow transducer 224 is capable of providing a real time electronic signal indicative of the total flow rate of the real-time prepared blend delivered from flow control valves 210 and 212 to the control system. Total flow transducer 224 can thus be used as a further check on the accuracy of flow transducers 206 and 208. Further, if desired, total flow transducer 224 could be plumbed to calibration vessel 220 so that the controlled recalibration of the same could be effected.

Property measuring device 226 is fluidly coupled to mixing manifold 214 and is located downstream therefrom. Although property measuring device may be any suitable device, property measuring device 226 is usefully a conductivity measuring device in HF etching applications. Property measuring device 226 is also in communication with the control system and provides real time electronic signals indicative of the measured conductivity of the blend exiting mixing manifold 214 thereto. These measurements could then be utilized by the control system to adjust any process parameter, such as time of the process, the flow rates provided from component supplies 204 and 202, and the like, if necessary.

As mentioned above, mixing manifold 214 delivers the real-time prepared blend to immersion vessel 216 via mixing manifold line 250. More specifically, mixing manifold line 250 is fluidly coupled to three way valve 258, which, in turn, is fluidly coupled to drain line 272 and immersion vessel feed line 274. Drain line 272 has operatively disposed in relation thereto drain flow transducer 262 for measuring drain flow and drain control valve 260 so that draining of immersion vessel 216 may be cause to occur at a relatively constant rate.

Three way valve 258 may be activated so as to allow flow to be discontinued from mixing manifold line 250 and immersion vessel 216 may be drained if desired. Alternatively, three way valve 258 may be activated so that flow is directed through immersion vessel feed line 274, so that real real-time prepared blend is delivered into treatment vessel 216.

Immersion vessel 216 has operatively disposed with respect thereto overflow weir 270, weir collection vessel 264 and dump containment vessel 283. In particular, overflow weir 270 is provided to provide for relatively uniform overflow about the edges of immersion vessel 216. Further, weir collection vessel 264 is operatively disposed in relation to dump containment vessel 283, and is shaped so that some portion of any such overflow may advantageously collect in the lower comer thereof, e.g., so as to be accessible for testing. Any overflow not collected by weir collection vessel 264 will thus collect in dump containment vessel 283. Further, quick dump valve 278 is provided in fluid connection with immersion vessel 216, so that when quick dump valve 278 is opened, the contents of immersion vessel 216 will be allowed to drain into dump containment vessel 283.

Further provided in operational disposition with immersion vessel 216 are lid 276, conductivity monitor 228 and drain line 288. More specifically, lid 276 is operationally disposed relative to immersion vessel 216 and/or weir collection vessel 264 so that lid 276 may be closed thereupon to provide a substantially contained processing environment. Lid 276 may include one or more means for the introduction of a variety of lines or sensing devices. As shown, lid 276 provides for the introduction of processing gas lines 290, 292 and 294, that can be used to deliver heated nitrogen gas, nitrogen gas, an EPA nitrogen mix to antistatic nozzles (not shown), as can be used in connection with certain semiconductor processes.

Lid 276 further provides for the introduction of measuring devices 296, 297, 298 and 299. More specifically, temperature measuring device 296 is provided and is operatively disposed within immersion vessel 216 so to be capable of monitoring the temperature of the blend delivered thereto. Low level measuring device 298, process level measuring device 297 and overflow measuring device 299 are provided to indicate when the level of the blend within the immersion vessel 216 is low, at a level suitable for immersion processing, or to indicate when the delivered blend has overflowed the immersion vessel 216 and is collecting to a certain level in weir collection vessel 264, respectively. All of measuring devices 296, 297, 298 and 299 may be in communication with the control system, so that one or more process adjustments may be made in response thereto, if desired.

Conductivity monitor 228 is operatively disposed relative to weir collection vessel 264, and as is the case with measuring devices 296, 297, 298 and 299, may be in communication with the control system so that the measurements obtained thereby can be utilized by the control system to make appropriate adjustments to any desired process parameters.

Drain line 288 is operatively disposed relative to dump containment vessel 600 and is operationally coupled thereto with an appropriate valve (not shown) that may be opened in order to drain containment vessel 283. Control line 286 is fluidly coupled to drain line 288 and has operatively disposed in relation thereto on-off valve and orifice 282. Control line 286 may be used, for example, to introduce appropriate amounts of hydrogen peroxide into drain line 288 for purposes of ozone abatement, when ozone is used in a process carried out in system 200.

System 200 further includes many additional components that may optionally be used in connection with some manufacturing processes. For example, system 200 includes component supply lines 231, 233 and 235 for fluidly coupling additional component supplies (not shown) to mixing manifold 214. Additional components that may be so provided and that are useful in some processes include additional hydrofluoric acid, ozonated water, or hydrochloric acid. In order to control the flows therethrough, component supply line 231 includes valves 237, 239 and 241, component supply line 233 includes valves 243, 245, and 247 and component supply line 235 includes valves 249, 251 and 253, all of which are operatively disposed relative to their respective supply lines.

In that instance where ozonated water is supplied via supply line 233, it is often desirable to provide a bypass line 255 to a drain, such as is shown in connection with system 200. In particular, bypass line 255 is fluidly coupled to component supply line 233 and has operatively disposed in relation thereto valve 257 to control flow therethrough. Additionally, in those processes where component supply line 235 is used to deliver hydrochloric acid to mixing manifold 214, it is often desirable to provide a flow sensing device, such as rotameter 259, in operational disposition with component supply line 235, to monitor the flow of the same.

One exemplary process that could be carried out in system 200 would be a cascading, single-use hydrofluoric acid etch. In order to do so, the control system would cause flow control valves 210 and 212 to allow deoxygenated deionized (DDI) water from component supply 204 and hydrofluoric acid (HF) from component supply 202, respectively, to be combined within mixing manifold 214. In particular, the control system would cause flow control valves 210 and 212 to provide a flow rate of DDI water and HF that would cause the blend to at least approximate the desired blend of DDI/HF, i.e., the concentration of HF. Flow transducers 206 and 208 would monitor the flow rate actually delivered to mixing manifold 214 by flow control valves 210 and 212 and would provide information based upon the monitoring to the control system. The control system would then adjust flow control valves 210 and 212, or other process parameters, as necessary or desired.

As mentioned above, in some applications it would be desirable to add small amounts of hydrochloric acid to a blended HF etchant. If such an application is desirable, the control system would cause on-off valve 253 to provide an appropriate amount of HCl to mixing manifold 214, as measured by rotameter 259.

With valve 254 positioned appropriately, the real-time prepared blend of HF would flow from mixing manifold 214 through mixing manifold line 250, coming into contact with total flow transducer 224 and property measuring device 226, which in that instance where HF is being used would desirably be a conductivity measuring device, each of which could provide electrical signals indicative of the total flow rate and conductivity, respectively, to the control system. If necessary, the control system could then use this information to adjust the flow rate being provided from flow control valves 210 and 212, to initiate a recalibration sequence of flow transducers 206 and 208, or to adjust any other process parameters, if necessary.

The blended etchant would proceed through mixing manifold line 250 through valve 258 when valve 258 is positioned appropriately, into and through immersion vessel feed line 274 and into the bottom of immersion tank 216. The level of the blend in the immersion tank is measured by level measuring devices 297, 298 and 299, and when the desired processing level is reached, one or more substrates (not shown) would be immersed therein.

At this time, the control system could advantageously cause flow control valves 206 and 208 to reduce the flow allowed therethrough proportionately, so as to provide the same concentration of HF as in the real time blend, but delivering the blend at a lower flow rate, or at a ‘cascade’ flow rate. The additional volume of delivered blend would cause immersion vessel 216 to overflow through overflow weir 270, and into either or both of weir collection vessel 264 and dump containment vessel 600. This continual flow of blend or other fluid into immersion vessel 216 can avoid the development of temperature or concentration gradients within immersion vessel 216 during processing, and further can act to remove any contamination from immersion vessel 216.

Additionally, during etching, the conductivity measuring device 228 could be caused to monitor the concentration of HF. Such measurements could be communicated to the control system that could then adjust any desired process parameter, as necessary or desired. Although conductivity measuring device 228 is shown to be on a sample loop adjacent and outside of immersion vessel 216, conductivity measuring device 228 could be otherwise operatively disposed relative to either weir collection vessel 264, or immersion vessel 216.

The end of the etch process may optionally be determined and controlled by the control system in response to measurements obtained from either or both of temperature measuring device 296 or conductivity measuring device 228. Advantageously, utilizing system 200 in this manner allows the control system, to dynamically control, in a feedforward fashion, the time of etching in response to the estimations based upon the flow rates of delivered components and/or blend, temperature and/or concentration of the blended etching solution.

Once the etch time had been reached, either as initially approximated, or as dynamically adjusted, the control system could cause flow control valves to close, thereby ceasing flow of blended HF to immersion tank 216. Immersion tank 216 could then be drained by opening quick dump valve 278 and drain valve (not shown) to allow the blended HF to drain out of dump containment vessel 283 and out drain line 288. Alternatively, supply of blended HF can be stopped followed by supply of a high flow rate of clean DI water for rinsing away the HF and to stop the etching process. In this case, the DI water merely replaces the blended HF within the vessel 283. Then the substrates can be dried by any suitable process.

Once immersion tank 216 is substantially empty, and the substrates therein have been dried, the control system could cause controllable valve 247 to open at a desired flow rate, thereby delivering ozonated water from an ozonated water supply (not shown) through component supply line 233, into mixing manifold 214 and through mixing manifold line 250 and into immersion vessel 216. This procedure can advantageously be used when a one tank etch, rinse and oxidation process is desirable.

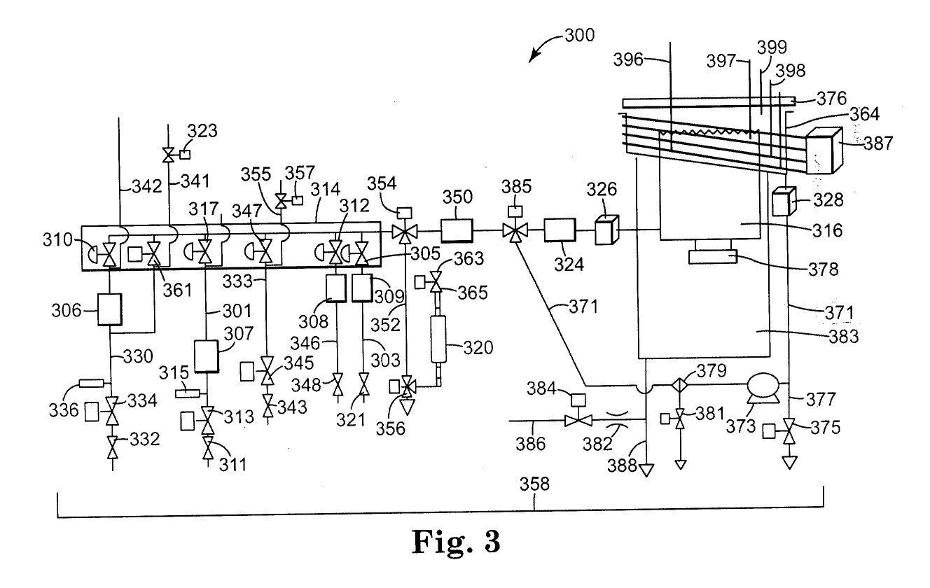

Referring now to FIG. 3, there is shown in more detail a recirculating system 300 useful for etching substrates with a buffered oxide etch. System 300 includes many of the same components as system 200, and duplicative components will not be discussed further. Rather, only the different structures present in system 300 will be described, while like components will be indicated with the same reference number as in system 200, increased by one hundred, i.e., reference number 220 in FIG. 2, referring to a calibration vessel will be calibration vessel 320 in FIG. 3.

In addition to those components already described in connection with FIG. 2, then, FIG. 3 further includes flow transducers 307 and 309, flow control valves, 317 and 305, heater/chiller 387 and recirculation line 371. System 300 further includes a control system (not shown) that responds to information generated by flow transducers 306, 307, 308, 309 and 324 as well as property measuring devices 326 and 328 to control any process parameter or any property of the blended etchant.

More specifically, a component supply of, e.g., a preblend HF solution (not shown) is fluidly coupled to mixing manifold 314 via component supply line 301. The flow from preblend HF component supply (not shown) to mixing manifold 314 is monitored by flow transducer 307 operatively disposed relative to component supply line 301 and in communication with the control system. Flow rate from the preblend HF component supply into mixing manifold 314 is controlled by controllable valve 317, also in communication with the control system. Component supply line 301 has operatively disposed relative thereto lockout valve 311, on-off valve 313 and pressure transducer 315 to assist in controlling flow from the preblend HF component supply.

A component supply (not shown), which can be ammonium hydroxide in some applications, is further provided and is coupled to mixing manifold 314 via component supply line 303. The flow from the ammonium hydroxide component supply to mixing manifold 314 is monitored by flow transducer 309 operatively disposed relative to component supply line 303 and in communication with the control system. Flow rate from the ammonium hydroxide component supply into mixing manifold 314 is controlled by controllable valve 305, also in communication with the control system. Component supply line 246 has operatively disposed relative thereto valve 321 upstream of flow transducer 309 to assist in controlling flow from the ammonium hydroxide component supply.

In addition to the components described hereinabove in connection with FIG. 2, immersion vessel 316 further includes heater/chiller 387 and recirculation line 371. More specifically, heater/chiller 387 is operatively disposed relative to immersion vessel 316, weir collection vessel 364 and recirculation line 371, so as to be able to heat or cool at least a portion of the contents of the same. As a result, system 300 advantageously provides a means of maintaining or adjusting the temperature of the contents of immersion vessel 316.

Recirculation line 371 fluidly connects weir collection vessel 364 with mixing manifold line 350 upstream of total flow transducer 324 and downstream of three way valve 354. Recirculation line 371 thus can be utilized to recirculate real-time prepared blend from weir collection vessel 364 back into the flow proceeding through mixing manifold line 350 and as a result, back into immersion vessel 316. Recirculation line 371 includes pump 373, filter 379 and three way valve 385.

More particularly, recirculation line 371 is fluidly and operatively connected to weir collection vessel 364 so that blended etchant may be directed therethrough. Pump 373 is operatively disposed relative to recirculation line 371 and may be used to provide for, or assist, the flow of blended etchant through recirculation line 371. Recirculation line 371 is fluidly connected to filter 379, including a valve (not shown) so that the contents of recirculation line 371 can be filtered, and filter 379 can be emptied. Recirculation line 371 then joins, and is fluidly coupled to, mixing manifold line 350 via three way bypass valve 385.

In particular, three way bypass valve 385 can be positioned so that flow proceeds from mixing manifold 314, through mixing manifold line 350 and into immersion vessel 316 to provided blended etchant to immersion vessel 316. Additionally, three way bypass valve 385 can be positioned so that blended etchant from recirculation line 371 enters mixing manifold line 350 and reenters immersion vessel 316, so that recirculation line 371 can recirculate blend within immersion vessel 316, thereby minimizing or preventing the formation of, any temperature or concentration gradients that may otherwise form within, and/or removing from containments from immersion vessel 316.

One exemplary process that could be carried out in system 300 would be a buffered oxide etch, or ‘BOE’, process, and would proceed as follows. The control system would cause flow control valves 310, 312 and 305 to allow cold filtered DI water, 49% HF and ammonium hydroxide, respectively, to be combined within mixing manifold 314. In particular, the control system would cause flow control valves 310, 312 and 305 to provide flow rates of DI water, 49% HF and ammonium hydroxide that would cause the blend to at least approximate a desired BOE solution. Flow transducers 306, 308 and 309 would monitor the flow rate actually delivered to mixing manifold 314 by flow control valves 310, 312 and 305 and provide information based upon the monitoring to the control system. The control system, in turn, could adjust any process parameter, such as the flow rates delivered by flow control valves 310, 317, 312 and 305, as necessary.

With three way bypass valves 354 and 385 positioned appropriately, the blended BOE would flow from mixing manifold 314 through mixing manifold line 350, coming into contact with total flow transducer 324 and property measuring device 326, desirably a concentration measuring device in BOE applications, each of which could provide electrical signals indicative of the total flow rate and concentration, respectively, to the control system. If necessary, the control system would then use this information to adjust any process parameter or property, such as, e.g., the flow rate provided by flow control valves 310, 312 and 305, or to cause the control system to initiate a calibration sequence of flow transducers 306, 308 and 309, if necessary.

As mentioned above, in some applications it would be desirable to add small amounts of hydrochloric acid to a blended etchant. If such an application is desirable, the control system would cause on-off valve 353 to provide an appropriate amount of HCl to mixing manifold 314, as measured by rotameter 359.

The blended BOE could proceed through mixing manifold line 350 into immersion vessel 316 by any appropriate dispensing method. The level of the blended BOE in the immersion tank 316 is measured by level measuring devices 397, 398 and 399, and when the processing level is reached, filling of recirculation line 371 could be initiated. Once recirculation line 371 and immersion vessel are sufficiently filled with blend, pump pump 373 could be started to being the flow of blended BOE from weir collection vessel 364 through recirculation line 371 and back into immersion vessel 316. Because recirculation line 371 and overflow collection weir 364 are operatively disposed relative to heater/chiller 387, the recirculated blended BOE solution can advantageously be heated or cooled prior to reentry into immersion tank 316. In this manner, recirculation line 371 can provide for the recirculation of the contents of immersion vessel 316, thereby assisting in the prevention of the formation of temperature or concentration gradients, and/or the removal of containments from, within immersion vessel 316 Once the processing level has been reached, and recirculation pump 373 started, one or more substrates would be immersed into immersion vessel 316. During etching, the conductivity measuring device 328 could be caused to monitor the concentration of the blended BOE to ensure that the proper concentration is maintained via communication with the control system. Further, temperature measuring device 396 can be caused to continually monitor the temperature of the blended BOE. The control system can then use these measurements, if necessary to adjust any process parameter.

The end of the etch process may optionally and advantageously be determined and controlled by the control system in response to measurements obtained from either or both temperature measuring device 396 and/or conductivity monitor 328. Advantageously, utilizing system 300 in this fashion would allow the control system to dynamically control, in a feedforward fashion, the time of etching in response to the temperature and/or concentration of one of the components of the blended BOE.

Once the etch time had been reached, either as initially approximated, or as dynamically adjusted, the substrates can be removed from the immersion vessel 316 and further processed as desired. Recirculation pump could continue to operate and a new substrate or set of substrates could be immersed into immersion vessel 316. Processing of many substrates or sets of substrates could thus be effected before there is a need to replace the contents of the immersion vessel 316.

Alternatively, the control system could cause controllable valve 347 to open at a desired flow rate, thereby delivering ozonated water from an ozonated water supply (not shown) through component supply 333, into mixing manifold, through mixing manifold line 350 and into immersion vessel 316. Quick dump valve 378 and the valve operationally disposed on dump containment vessel 370 can then be opened. In this fashion, immersion vessel 316 is flushed out, while the simultaneously rinsing of the substrates therein is effected.

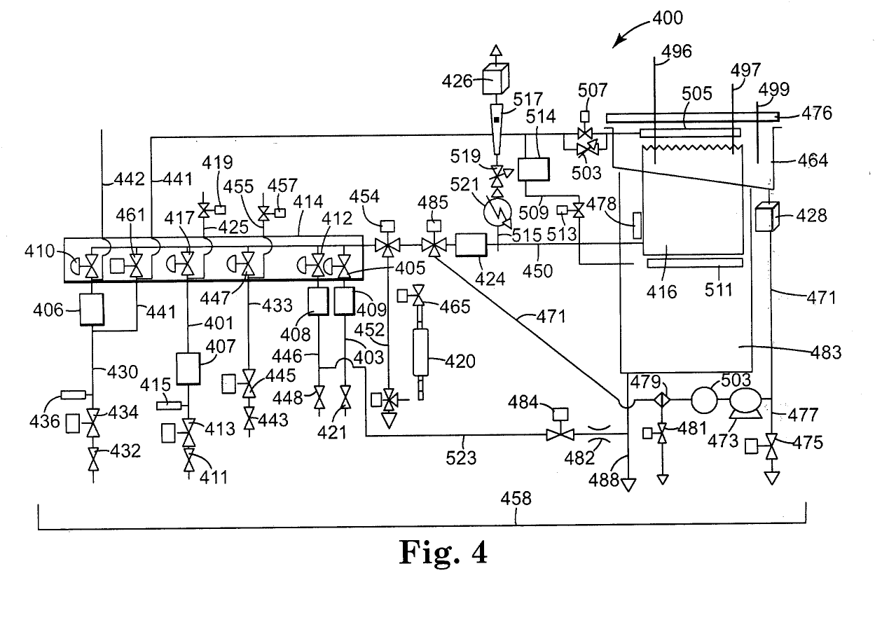

Referring now to FIG. 4, there is shown a recirculating system 400 useful for cleaning substrates, e.g., according to an SC1 cleaning process. System 400 includes many of the same components as systems 200 and 300, and duplicative components will not be discussed further. Rather, only the different structures present in system 400 will be described, while like components will be indicated with the same reference number as in systems 200 and 300, increased by one or two hundred as the case may be. Thus, reference number 220 in FIG. 2, referring to a calibration vessel will be calibration vessel 420 in FIG. 4 and recirculation line 371 in FIG. 3 will be recirculation line 471 in FIG. 4.

In addition to those components already described in connection with FIGS. 2 and 3, then, FIG. 4 further includes heater 503, spray bar(s) 505, megasonic components 509, 511, 513 and 514, means for off-lining the measurement provided by property measuring device 426, and means for providing hydrogen peroxide to drain line 488 for purposes of ozone abatement.

As shown in FIG. 4, bypass line 441 is fluidly coupled to one or more spray bars 505 operatively disposed within immersion vessel 416. Adjustable needle 503 and adjustable bypass valve 507 are also provided in fluid connection with bypass line 441, so that although the flow of component delivered through bypass line 541 via bypass valve 507, needle 503 will always allow at least some amount of flow through bypass line 541 and through spray bars 505, e.g., to minimize or prevent the proliferation of any bacteria therein.

Megasonic components 509, 511, 513 and 514 are operatively disposed relative to bypass line 441 via any appropriate valve connection (not shown). More specifically, megasonic components include megasonic supply line 509, degas module 514, on-off valve 513, and transducer array 511. Megasonic component supply line 509 is fluidly connected to bypass line 441 by a valve (not shown). On-off valve 513 is operatively disposed relative to megasonic supply line 509 in order to assist in the control of the flow of fluid therethrough. Further, degas module 514 is fluidly coupled to supply line 509 as well as being operationally coupled to a vacuum source (not shown) so as to be capable of removing any bubbles from fluid delivered through supply line 509. Supply line 509 provides degassed fluid to the space between transducer array 511 and immersion vessel 416 to provide a medium for transferring megasonic energy to the bottom surface of the immersion vessel 416. Due to the inclusion of megasonic components 509, 511, 513 and 514 in system 400, immersion vessel 416 can provide for the megasonic processing of substrates, if desired.

System 400 further provides for the additional flow of hydrogen peroxide through hydrogen peroxide supply line 523. Specifically, hydrogen peroxide supply line is fluidly coupled to component supply line 446 at its upstream terminus and is fluidly coupled to drain line 488 at its downstream terminus. In this fashion, hydrogen peroxide can be provided to drain line 488 if desired, to perform, e.g., ozone abatement.

System 400 further provides for the off-line measurement of any desired property of the blend produced by system 400 with property measuring device 426. Specifically, measurement supply line 515 is provided and is fluidly connected to mixing manifold line 450 via any suitable valve connection (not shown). Any number or combination of desired property measuring devices could be operationally disposed relative to measurement supply line 515, system 400 illustrates in particular, concentration analyzer 426 and rotameter 517. Rotameter 517 has operationally disposed in relation thereto adjustable valve 519 so that the flow of fluid into concentration analyzer 426 can be adjusted if desired. Further operationally disposed relative to measurement supply line 515 is chiller 521 which can be used to reduce the temperature of blend or fluid flowing through supply line 515 prior to reacting concentration analyzer 426, if desired.

One exemplary process that could be performed using system 400 would be an SC1 cleaning process. In order to perform such a process, the control system could intitially, if the same was desired, cause flow control valve 447 to allow ozonated water to pass into mixing manifold 414, through mixing manifold line 450 and into immersion vessel 416 to perform pre-rinse. If performed, and once the ozonated water had been removed from immersion vessel 416 via the operation of dump containment vessel valve, the control system would cause flow control valves 410, 417, 412 and 405 to allow cold filtered DI water, hot pressure regulated filtered DI water, hydrogen peroxide and ammonium hydroxide, respectively, to be combined within mixing manifold 414 to produce a cleaning blend having at least an approximation of a desired composition and temperature. Flow transducers 406, 407, 408 and 409 would monitor the flow rate actually delivered to mixing manifold 414 by flow control valves 410, 417, 412 and 405 and provide information based upon the same to the control system. The control system, in turn, could adjust the, any process or property parameter, such as, e.g., the flow rates delivered by flow control valves 410, 417, 412 and 405, if necessary or desired.

With three way bypass valves 454 and 485 positioned appropriately, the blended cleaning solution would flow from mixing manifold 414 through mixing manifold line 450, coming into contact with total flow transducer 424 which could provide an electrical signal indicative of the total flow rate to the control system. If necessary, the control system would then use this information to adjust any process or property parameter.

The blended cleaning solution could proceed through mixing manifold line 450 into immersion vessel 416 by any dispensing method, such as spargers. The level of the blended cleaning solution in the immersion tank 316 is measured by level measuring devices 497 and 499, and when the desired processing level is reached, filling of recirculation line 471 could be initiated. Once recirculation line 371 and immersion vessel are sufficiently filled with blend, pump 473 could be started to being the flow of blended BOE from weir collection vessel 464 through recirculation line 471 and back into immersion vessel 316. Because recirculation line 471 has operatively disposed relative thereto heater 503, the recirculated blended BOE solution can advantageously be heated prior to reentry into immersion tank 416. In this manner, recirculation line 371 can provide for the recirculation of the contents of immersion vessel 416, thereby assisting in the prevention of the formation of temperature or concentration gradients, and/or the removal of containments from, within immersion vessel 416.

One or more substrates may be placed within immersion vessel 416 prior to or after immersion vessel 416 has been substantially filled with blend. Advantageously, if the substrates are placed within immersion vessel 416, the act of filling immersion vessel 416, coupled with the megasonic action provide by transducer array 511 can provide advantageous processing effects. Alternatively, one or more substrates can be immersed into immersion vessel 416 once immersion vessel 416 has been filled and recirculation pump 473 started.

During cleaning, the conductivity measuring device 428 could be caused to monitor the concentration of any component of the blended cleaning solution to ensure that the proper concentration is maintained via communication with the control system. Further, temperature measuring device 496 can be caused to continually monitor the temperature of the blended cleaning solution. The control system could adjust any processing parameter based upon the information received from temperature measuring device 496 and/or conductivity measuring device 428 The end of the cleaning process can optionally be determined and controlled by the control system in response to measurements obtained from other or both of the temperature measuring device 496 and the conductivity monitor 428. Advantageously, utilizing system 400 in this fashion would allow the control system to dynamically control, in a feedforward fashion, the time of cleaning in response to the temperature and/or concentration of one of the components of the blended cleaning solution.

Once the clean time had been reached, either as initially approximated, or as dynamically adjusted, quick dump valve 478 and valve (not shown) in fluid connection with dump containment vessel 483 can desirably be opened to allow the blended cleaning solution to drain out of dump containment vessel 483 and out drain line 488. Once immersion tank 416 is substantially empty, the control system could cause flow control valve 461 to deliver water through bypass line 441 to spray bars 505, advantageously resulting in the substrates being effectively rinsed thereby. Further, if desirable a series of quick dump cycles could be initiated, where immersion vessel 416 is repetitively filled and emptied via the flow from spray bars 505 and the operation of the dump containment vessel valve, respectively.

Numerous characteristics and advantages of the invention meant to be described by this document have been set forth in the foregoing description. It is to be understood, however, that while particular forms or embodiments of the invention have been illustrated, various modifications, including modifications to components of the system and the arrangement thereof, and the like, can be made without departing from the spirit and scope of the invention.

What is claimed is:

1. An immersion system for surface conditioning semiconductor devices having an immersion vessel and further comprising:
a first flow control device fluidly coupled to a first component supply;
a second flow control device fluidly coupled to a second component supply;
a mixing manifold fluidly coupled to the first and second component supplies and for supplying a solution comprising the first and second components to the immersion vessel;
a first measuring device operatively disposed relative to the immersion system;
a control system in communication with the first measuring device, first flow control device, and second flow control device so that measurements from the measuring device can be utilized to dynamically adjust at least one of the first and second flow control devices in response thereto.

2. The system of claim 1, wherein at least one of the first flow control device and the second flow control device comprise a controllable valve.

3. The system of claim 1, wherein the first measuring device measures a process parameter.

4. The system of claim 3, wherein the process parameter measured is time, flow rate, or delivered volume.

5. The system of claim 1, further comprising a second measuring device operatively disposed relative to the solution and in communication with the control system.

6. The system of claim 5, wherein the second measuring device measures a property of the solution.

7. The system of claim 6, wherein the property measured is pH, temperature, conductivity, concentration, density, or pressure.

8. The system of claim 5, wherein the second measuring device measures a process parameter.

9. The system of claim 8, wherein the process parameter measured is time, flow rate, or delivered volume.

10. The system of claim 5, wherein one or more measurements from the second measuring device are used by the control system to independently dynamically adjust at least one of the first and second flow control devices.

11. The system of claim 5, further comprising a third measuring device operatively disposed relative to the solution and in communication with the control system.

12. The system of claim 11, wherein the third measuring device measures a property of the solution.

13. The system of claim 12, wherein the property measured is pH, temperature, conductivity, concentration, density or pressure.

14. The system of claim 11, wherein the third measuring device measures a process parameter.

15. The system of claim 14, wherein the process parameter measured is time, flow rate, or delivered volume.

16. The system of claim 11, wherein one or more measurements from the second measuring device are used by the control system to independently dynamically adjust at least one of the first and second flow control devices.

17. The system of claim 1, further comprising at least one calibration device in communication with the controller and the first flow control device and operatively disposed in relation to the first component supply so that information from the calibration device can be utilized to dynamically calibrate the first flow control device in response thereto.

18. The system of claim 1, further comprising at least one calibration device in communication with the controller and the second flow control device and operatively disposed in relation to the second component supply so that information from the calibration device can be utilized to dynamically calibrate the second flow control device in response thereto.

19. The system of claim 1, further comprising a recirculation line operatively disposed relative to at least one of the mixing manifold and the immersion vessel.

20. A method for providing a real-time blended solution having a desired property from a plurality of fluid components and then using the blend to immersively surface condition at least one semiconductor device, comprising:
determining a flow rate of the plurality of fluid components that, when the at least two components are caused to be combined at the determined flow rate, would produce a blend having at least an approximation of the desired property;
causing the at least two components to be combined at the determined flow rate;
dynamically measuring on a real time basis at least one of (i) the flow rate of at least one of the components and (ii) the desired property of the blended solution;
adjusting the flow rate of at least one of the at least two components in response to the measurement until the desired property is substantially obtained in the blend; and
immersively surface conditioning the at least one semiconductor device with the blended solution.

21. The method of claim 20, wherein the measuring step comprises measuring the flow rate of at least one of the components.

22. The method of claim 20, wherein the measuring step comprises independently measuring the flow rates of each of the at least two components.

23. The method of claim 22, wherein the desired property of the blended solution is dynamically measured.

24. The method of claim 23, further comprising the step of substantially maintaining the desired property of the blended solution during at least a portion of the immersive surface treatment step.

25. The method of claim 24, wherein the step of maintaining the desired property of the blended solution comprises continuing to combine the at least two components while dynamically measuring the desired property and adjusting the flow rate of at least one of the at least two components in response to the measurement.

26. The method of claim 20, further comprising the steps of removing the at least one semiconductor device from immersive contact with the blended solution and subjecting the at least one semiconductor device to a further processing step and wherein the information obtained from measuring is utilized to provide closed loop feedforward control of the further processing step.
